(19) United States
(12) Patent Application Publication
(10) Pub. No.: US 2013/0212291 A1
(43) Pub. Date: Aug. 15, 2013

(54) METHOD AND APPARATUS FOR STREAMING A SERVICE FOR PROVIDING SCALABILITY AND VIEW INFORMATION

(71) Applicants: Jin Young Lee, Daejeon (KR); Jae Gon Kim, Goyang (KR); Euy Doc Jang, Goyang (KR); Truong Cong Thang, Deajeon (KR); Soon Heung Jung, Daejeon (KR); Seong Jun Bae, Daejeon (KR); Sang Taick Park, Daejeon (KR); Won Ryu, Daejeon (KR); Jung Won Kang, Daejeon (KR)

(72) Inventors: Jin Young Lee, Daejeon (KR); Jae Gon Kim, Goyang (KR); Euy Doc Jang, Goyang (KR); Truong Cong Thang, Deajeon (KR); Soon Heung Jung, Daejeon (KR); Seong Jun Bae, Daejeon (KR); Sang Taick Park, Daejeon (KR); Won Ryu, Daejeon (KR); Jung Won Kang, Daejeon (KR)

(73) Assignees: INDUSTRY-UNIVERSITY COOPERATION FOUNDATION KOREA AEROSPACE UNIVERSITY, Goyang-si Gyeonggi-do (KR); Electronics and Telecommunications Research Institute, Daejeon (KR)

(21) Appl. No.: 13/811,379

(22) PCT Filed: Jul. 20, 2011
(86) PCT No.: PCT/KR2011/005333

§ 371 Date: Apr. 4, 2013

Related U.S. Application Data
(60) Provisional application No. 61/365,854, filed on Jul. 20, 2010.

(30) Foreign Application Priority Data
May 12, 2011 (KR) 10-2011-0044564

(51) Int. Cl. H04L 29/06

(52) U.S. Cl. CPC H04L 65/607
USPC 709/231

(57) ABSTRACT

A method and apparatus for inserting scalability and view information into a Moving Picture Experts Group-2 (MPEG-2) Transport Stream (TS) header are provided. When a scalable video or multi-view video is transmitted using an MPEG-2 system, scalability information or view information regarding the scalable video or multi-view video in a payload in a TS level may be used. Using the scalability information or view information, the TS-packetized scalable video or multi-view video may be efficiently adapted to various terminal performances, various network characteristics, a specific user preference, and the like.

### TECHNICAL FIELD

The following embodiments relate to a method and apparatus for a streaming service.

A method and apparatus for inserting scalability and view information into a stream header are provided.

### BACKGROUND ART

A Moving Picture Experts Group-2 (MPEG-2) system may perform a process of packetizing and multiplexing an Element Stream (ES) generated in a video part and an audio part, to store or transmit the ES.

The process may be broadly divided into two operations.

One of the two operations may be performed to generate a Program Stream (PS) to be stored in a storage medium.

The other operation may be performed to generate a Transport Stream (TS) to be transmitted or broadcasted over a network.

When a scalable video is transmitted through a TS of the MPEG-2 system, efficient scalability in a TS level needs to be supported.

In existing methods, scalability information of a scalable video in a payload of a TS may be identified based on Program Specific Information (PSI).

When the methods are used, the MPEG-2 system may be periodically synchronized with the PSI, and may analyze the PSI all the time, to use the scalability information.

Additionally, to efficiently use various scalable layers provided in the scalable video, it is inevitable to increase the PSI and an overhead of a Packetized Elementary Stream (PES).

Furthermore, the scalability information of the scalable video in the payload of the TS may be provided from the TS using a Packet Identifier (PID) based on the PSI.

Accordingly, a separate ES needs to be formed for each scalable layer to be identified in the TS level, and a PID needs to be assigned.

To identify various scalable layers in the TS level, a large number of ESs need to be formed. The need to form a large number of ESs may complicate a structure of a TS generator (namely, a multiplexer), and a structure of a TS demultiplexer.

Accordingly, there is a need to introduce a method of using efficient scalability information in a TS level.

### DISCLOSURE OF INVENTION

### Technical Goals

An aspect of the present invention provides a streaming apparatus and method that may provide scalability information and view information.

### Technical solutions

According to an aspect of the present invention, there is provided a streaming server, including: a packet generator to generate a Moving Picture Experts Group-2 (MPEG-2) Transport Stream (TS) packet; and a transmitter to transmit an MPEG-2 TS using the MPEG-2 TS packet, wherein the MPEG-2 TS includes a scalable video stream, and wherein a header of the MPEG-2 TS packet includes scalability information of the scalable video stream.

The scalable video stream may be divided, and the divided scalable video stream may exist in a payload of the MPEG-2 TS packet.

The scalability information may exist in transport private data of the header.

The transport private data may exist in an optional field in an adaptation field of the header.

The header may include a scalability information flag indicating presence or absence of the scalability information, and a view information flag indicating presence or absence of view information of the scalable video stream.

The header may include a private data flag indicating whether the scalability information flag and the view information flag exist.

The scalability information may include spatial scalability information of the scalable video stream, temporal scalability information of the scalable video stream, and quality scalability information of the scalable video stream.

The view information may exist in the transport private data of the header.

The packet generator may generate the view information using second view information in a Network Abstraction Layer Unit (NALU) header of a Multi-view Video Coding (MVC).

The packet generator may generate the scalability information using second scalability information in a NALU header of a Scalable Video Coding (SVC).

The packet generator may generate the scalability information only when data of the NALU header exists in the MPEG-2 TS packet.

The packet generator may generate the scalability information in only the MPEG-2 TS packet including the data of the NALU header, among at least one MPEG-2 TS packet having the same Packet Identifier (PID).

The packet generator may include a scalability information inserter to insert the scalability information into the MPEG-2 TS packet.

According to another aspect of the present invention, there is provided a streaming client, including: a receiver to receive an MPEG-2 TS; and a packet processor to process an MPEG-2 TS packet in the MPEG-2 TS, wherein the MPEG-2 TS includes a scalable video stream, and wherein a header of the MPEG-2 TS packet includes scalability information of the scalable video stream.

The packet processor may determine whether the scalability information and view information of the scalable video stream exist in the packet, based on a scalability information flag and a view information flag that are included in the header.

The packet processor may generate, based on the scalability information, scalability information in a NALU header of a SVC.

The packet processor may extract the scalability information, only when data of the NALU header is included in the MPEG-2 TS packet.

The packet processor may extract the scalability information from only the MPEG-2 TS packet including the data of the NALU header, among at least one MPEG-2 TS packet having the same PID.

The packet processor may extract the scalability information of the MPEG-2 TS packet from a second MPEG-2 TS packet of a previous time that includes the scalability information and that is located closest to the MPEG-2 TS packet, among the at least one MPEG-2 TS packet having the same PID.

According to still another aspect of the present invention, there is provided a streaming service method, including: generating an MPEG-2 TS packet; and transmitting an MPEG-2 TS generated using the MPEG-2 TS packet, wherein the MPEG-2 TS includes a scalable video stream, and wherein a header of the MPEG-2 TS packet includes scalability information of the scalable video stream.

### Effect of the Invention

It is possible to provide scalability information in a Transport Stream (TS) level, by extending a TS header, and by inserting the scalability information into the extended TS header.

It is possible to transmit scalability information and view information using a TS header, without a change in existing syntax and meaning.

It is possible to reduce an overhead of a TS header by inserting scalability information into only a TS packet header in which a Network Abstraction Layer Unit (NALU) header exists.

### BRIEF DESCRIPTION OF DRAWINGS

FIG. 1 is a diagram illustrating a configuration of an extended Transport Stream (TS) header 112 according to an embodiment of the present invention;

FIG. 2 is a diagram illustrating a configuration of an optional field 152 according to an embodiment of the present invention;

FIG. 3 is a diagram illustrating a syntax defined by extending transport private data 220 of the TS header 112, to transmit scalability information according to an embodiment of the present invention;

FIG. 4 is a diagram illustrating a structure of an adaptation field 138 containing the transport private data 220;

FIG. 5 is a diagram illustrating a method for inserting scalability information into the TS header 112, using scalability information included in a Network Abstraction Layer Unit (NALU) header of Scalable Video Coding (SVC), according to an embodiment of the present invention;

FIG. 6 is a diagram illustrating a structure of a streaming server 600 according to an embodiment of the present invention;

FIG. 7 is a diagram illustrating a structure of a streaming client 700 according to an embodiment of the present invention; and

FIG. 8 is a flowchart of a streaming service method 800 according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

In the following embodiments of the present invention, a Transport Stream (TS) header may be extended, and scalability information may be inserted into the extended TS header, and thus scalability information in a TS level may be provided.

The scalability information in the TS level according to embodiments of the present invention may provide an efficient video adaptation scheme.

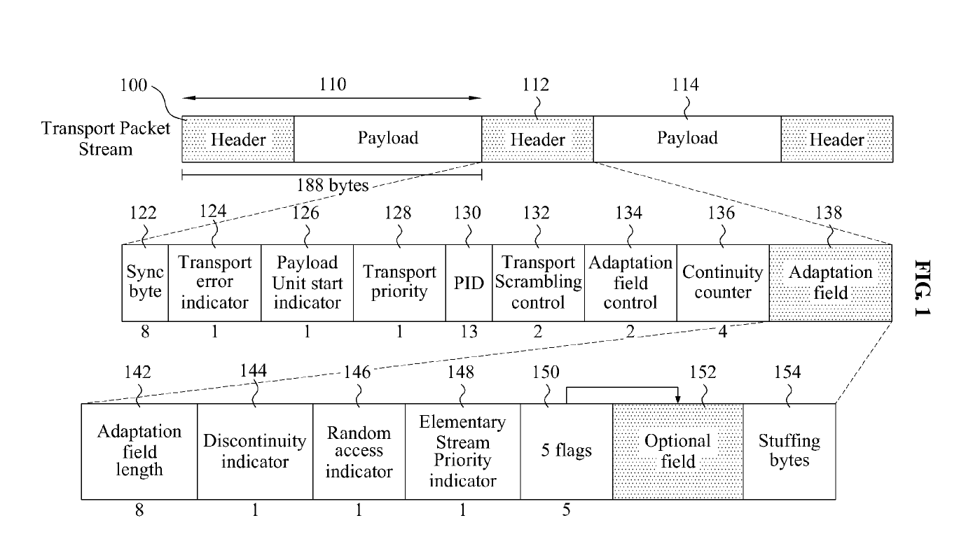

FIG. 1 is a diagram illustrating a configuration of an extended TS header 112 according to an embodiment of the present invention.

A TS packet stream 110 may include a TS packet 110.

The TS packet may include a header 112 (namely, a TS header), and a payload 114.

The TS packet 110 has a fixed length of 188 bytes.

The header 112 may include a sync byte 122, a transport error indicator 124, a payload unit start indicator 126, a transport priority 128, a Packet Identifier (PID) 130, a transport scrambling control 132, an adaptation field control 134, a continuity counter 136, and an adaptation field 138.

A length of each field (namely, bits forming each field) is shown as numerals in a lower part of each field. For example, the sync byte 122 may correspond to 8 bits.

The sync byte 122 may be byte-aligned. Accordingly, when the sync byte 122 is found from the TS 100 through byte alignment, the TS packet 110 may be extracted.

Each TS packet 110 may contain different payloads 114. To identify the different payloads 114, the PID 130 may exist in the header 112.

Additionally, the adaptation field control 134 used to indicate presence or absence of a payload may exist in the header 112. The adaptation field control 134 may indicate presence or absence of the adaptation field 138. The adaptation field control 134 may be included in the payload 114 of the TS packet 110.

The adaptation field 138 may include an adaptation field length 142, a discontinuity indicator 144, a random access indicator 146, an elementary stream priority indicator 148, 5 flags 150, an optional field 152, and stuffing bytes 154.

The 5 flags 150 in the adaptation field 138 may be used to indicate presence or absence of a variety of information in the optional field 152.

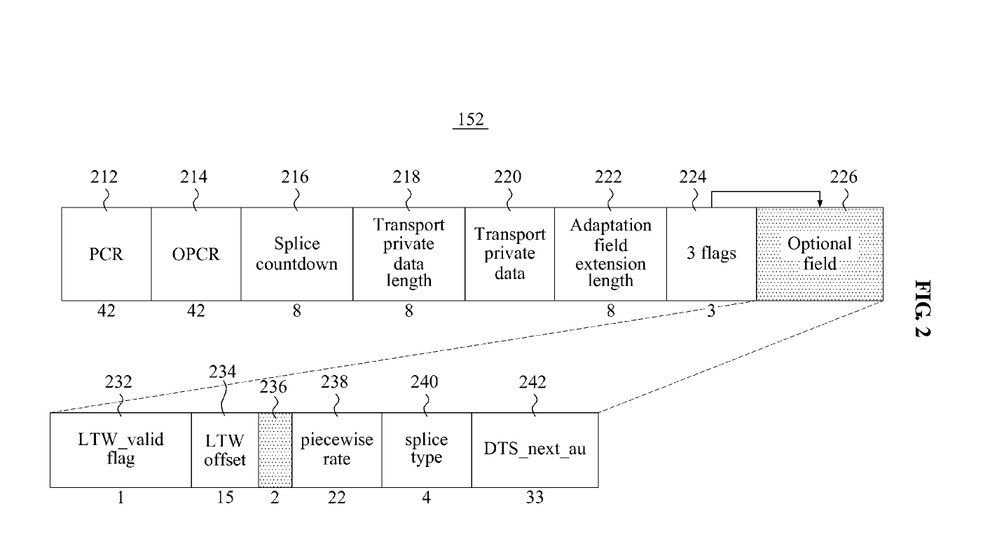

FIG. 2 is a diagram illustrating a configuration of the optional field 152 according to an embodiment of the present invention.

The optional field 152 may include a Program Clock Reference (PCR) 212, an Original Program Clock Reference (OPCR) 214, a splice countdown 216, a transport private data length 218, transport private data 220, an adaptation field extension length 222, 3 flags 224, and an optional field 226.

In the optional field 152 with respect to the 5 flags 150, the transport private data 220 may be used to transmit data that is not defined in the standard.

When a scalable video is transmitted, scalability information may be inserted into the transport private data 220.

The above-described 5 flags 150 are used to indicate presence or absence of the transport private data 220, and accordingly it is possible to determine whether the scalable video exist in the payload 114.

The optional field 226 may include a Legal Time Window (LTW)_valid flag 232, an LTW offset 234, a reserved field 236, a piecewise rate 238, a splice type 240, and a Decording Time Stamp (DTS)_next_au 242.

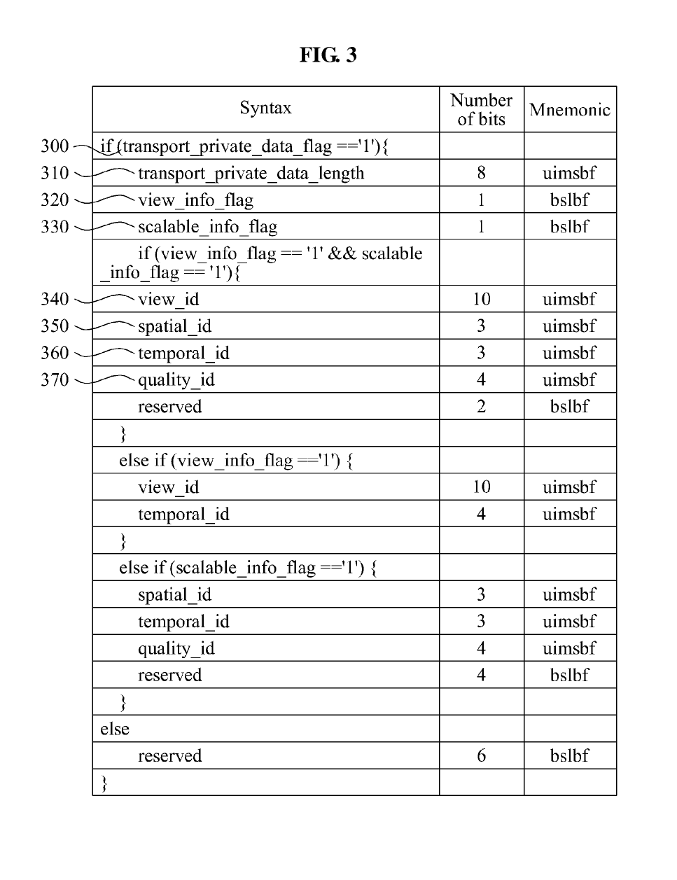

FIG. 3 is a diagram illustrating a syntax defined by extending the transport private data 220 of the TS header 112, to transmit scalability information according to an embodiment of the present invention.

FIG. 3 illustrates the syntax, a number of bits of each field, and mnemonics, in association with the extended transport private data 220.

When scalability and view information is included in transport private data in a scalable video or multi-view video, existing syntax and semantics of the transport private data may be used without any change, and only the transport private data may be extended and defined as shown in FIG. 3.

Accordingly, a transmitter and a receiver may require a rule to insert scalability information and view information using private data.

A transport_private_data_flag 300 may indicate that a transport_private_data_length 310, a view_info_flag 320, and a scalable_info_flag 330 exist.

The view_info_flag 320 may be used to indicate that view information exists.

The scalable_info_flag 330 may be used to indicate that scalability information exists.

A value of the view_info_flag 320 and a value of the scalable_info_flag 330 may be used to determine which information is to be transmitted, and to determine which information is included.

When both the view_info_flag 320 and the scalable_info_flag 330 have a value of “1,” a view_id 340, a spatial_scalability (or a spatial_id) 350, a temporal_scalability (or a temporal_id) 360, and a quality_scalability (or a quality_id) 370 may be transmitted, and 2 bits may be reserved.

When only the view_info_flag 320 has a value of “1,” the view_id 340 and temporal_id may be transmitted.

When only the scalable_info_flag 330 has a value of “1,” the spatial_id 350, the temporal_id 360, and the quality_id 370 may be transmitted, and 4 bits may be reserved.

When the view_info_flag 320 and the scalable_info_flag 330 have values other than “1,” 6 bits may be reserved.

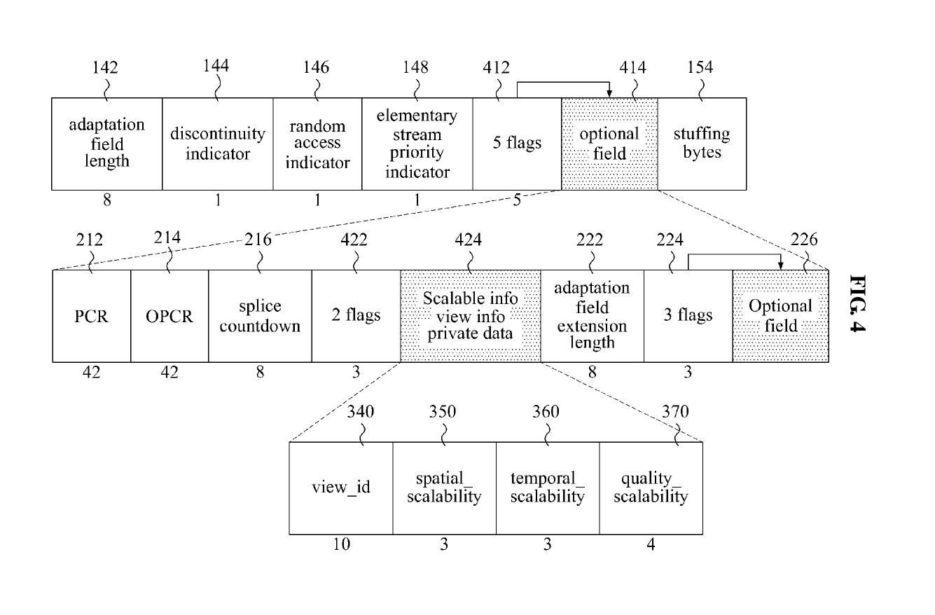

FIG. 4 is a diagram illustrating a structure of the adaptation field 138 containing the transport private data 220.

The TS header 112 generally has a size of 4 bytes, and may transmit required information using the adaptation field 138, as needed.

Within the adaptation field 138, the adaptation field length 142 may represent the total length of the adaptation field 138.

To use the transport private data 220 existing in the adaptation field 138, whether an optional field 414 behind 5 flags 412 is used may be determined using the 5 flags 412.

When a transport private data flag among the 5 flags 412 has a value of ‘1,’ 2 flags 422 in the optional field 414 may determine whether to transmit view info/scalable info/private data 424 through the transport private data 220.

When the view_info_flag 320 has a value of ‘1,’ the view_id 340 may be transmitted.

When the scalable_info_flag 330 has a value of ‘1,’ information of the spatial_id 350, information of the temporal_id 360, and information of the quality_id 370 may be transmitted.

By using the TS header 112 having the above-described structure, scalability information and view information may be transmitted, without a change in the existing syntax and meaning.

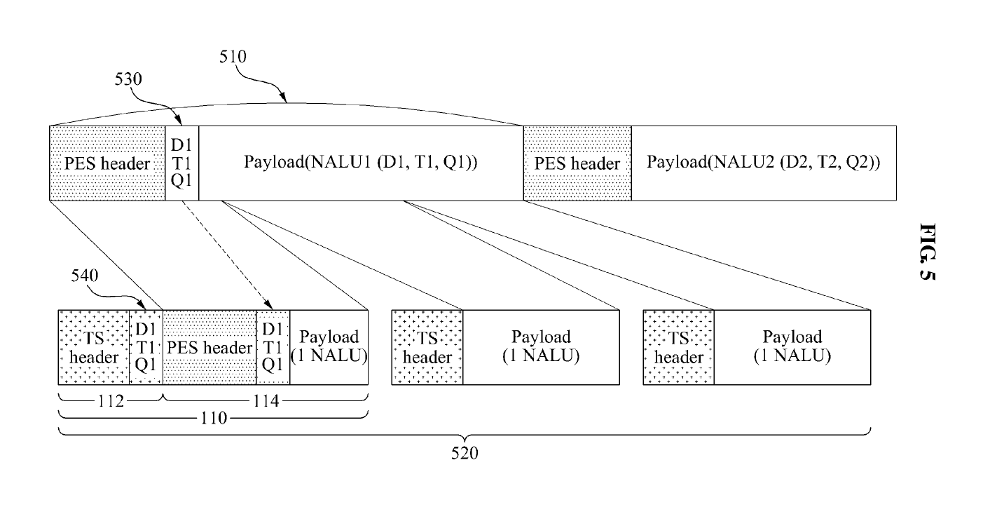

FIG. 5 illustrates a method for inserting scalability information into the TS header 112, using scalability information included in a Network Abstraction Layer Unit (NALU) header of Scalable Video Coding (SVC), according to an embodiment of the present invention.

The SVC is one of scalable video standards.

Scalability information 540 may include a dependency_id, a temporal_id, and a quality_id. The dependency_id may be represented by D1, D2, and the like, in sequence. The temporal_id may be represented by T1, T2, and the like, in sequence. The quality_id may be represented by Q1, Q2, and the like, in sequence.

A single NALU may be packetized to a PES 510.

The PES 510 may be packetized into several TS packets 520 having the same PID.

When a single NALU is divided and packetized in several TS packets 110, scalability information of a corresponding NALU may be inserted into the header 112 of each of the TS packets 110.

However, when the scalability information is inserted into all of the TS packets 110, overhead of the TS header 112 may be increased, and overlapping information regarding a single NALU may be inserted.

Accordingly, scalability information may be inserted into only a TS packet header in which a NALU header 530 exists, among TS packets having the same PID, rather than into the headers 112 of all the TS packets 110. Additionally, the overhead of the TS header 112 may be reduced.

Thus, the scalability information 540 of a corresponding NALU may be inserted into only the header 112 of the TS packet 110, into which the NALU header 530 is inserted into the payload 114.

The above-description of the scalability information 540 of the NALU may also be applied to view information of the NALU. Here, the NALU may be a NALU of Multi-view Video Coding (MVC).

For example, when a single NALU is divided and packetized in several TS packets 110, view information of a corresponding NALU may be inserted into the header 112 of each of the TS packets 110. Additionally, the view information of a corresponding NALU may be inserted into only the header 112 of the TS packet 110, into which the NALU header 530 is inserted into the payload 114.

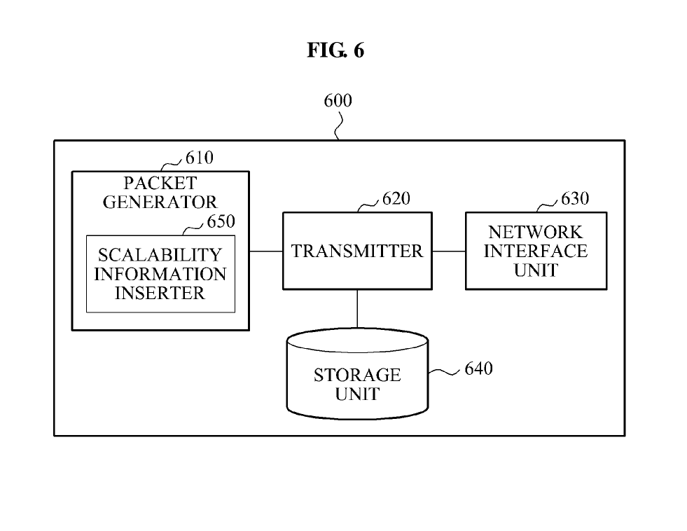

FIG. 6 is a diagram illustrating a structure of a streaming server 600 according to an embodiment of the present invention.

The streaming server 600 may be an MPEG-2 TS generation apparatus that generates an MPEG-2 TS.

The streaming server 600 may include a packet generator 610, and a transmitter 620.

The packet generator 610 may generate the above-described TS packet 110.

The transmitter 620 may transmit the TS 100 using the TS packet 110. The TS 100 may include a scalable video stream. The scalable video stream may be divided, and the divided scalable video stream may exist in the payload 114 of the TS packet 110. In other words, at least one TS packet 110 forming the TS 100 may include the scalable video stream in the payloads 114.

The transmitter 620 may transmit the TS 100 to a streaming client 700, such as a video player, via a network interface unit 630.

The transmitter 620 may store the TS 100 in a storage unit 640 included in the streaming server 600.

The header 112 of the TS packet 110 may include scalability information of the scalable video stream.

The packet generator 610 may include a scalability information inserter 650.

The scalability information inserter 650 may insert (or add) the scalability information into the TS packet 110 that are already generated.

Accordingly, the above-described scalability information may be generated by the packet generator 610, and may be inserted into the TS packet 110 by the scalability information inserter 650.

The scalability information may exist in the transport private data 220. In other words, the packet generator 610 may generate the scalability information in the transport private data 220. Additionally, to insert the scalability information into the TS packet 110, the scalability information inserter 650 may change the transport private data 220, and other parts of the TS packet 110 that are associated with the transport private data 220.

The packet generator 610 may include the view_info_flag 320 indicating presence or absence of the view information of the scalable video stream, and the scalable_info_flag 330 indicating presence or absence of the scalability information. The packet generator 610 may generate the scalable_info_flag 330 and the view_info_flag 320 in the header 112. The scalability information inserter 650 may set the value of the scalable_info_flag 330 based on the presence or absence of the scalability information, and may set the value of the view_info_flag 320 based on the presence or absence of the view information.

The scalability information may exist in the adaptation field 138 in the transport private data 220 of the TS header 112. Additionally, the scalability information may exist in the optional field 152 in the adaptation field 138.

The view information may exist in the adaptation field 138 in the transport private data 220 of the TS header 112. Additionally, the scalability information may exist in the optional field 152 in the adaptation field 138.

The transport_private_data_flag 310 of the TS header 112 may indicate whether the scalable_info_flag 330 and the view_info_flag 320 exist. The packet generator 610 may generate the transport_private_data_flag 310 in the header 112. The scalability information inserter 650 may set a value of the transport_private_data_flag 310 based on whether the scalable_info_flag 330 and the view_info_flag 320 exist.

The scalability information may include at least one of the spatial_id 350, the temporal_id 360, and the quality_id 370.

The packet generator 610 may generate view information, using view information included in the NALU header 530 of the MVC. Alternatively, the scalability information inserter 650 may insert the view information into the TS header 112, using the view information included in the NALU header 530 of the MVC.

Additionally, the packet generator 610 may generate scalability information, using scalability information included in the NALU header 530 of the SVC. Alternatively, the scalability information inserter 650 may insert the scalability information into the TS header 112, using the scalability information included in the NALU header 530 of the SVC.

The packet generator 610 may generate scalability information, only when data of the NALU header 530 exists in the TS packet 110. The scalability information inserter 650 may insert the scalability information into only the TS packet 110 including the data of the NALU header 530.

At least one MPEG-2 TS packet may have the same PID.

The packet generator 610 may generate scalability information in only the TS packet 110 including the data of the NALU header 530 among the at least one MPEG-2 TS packet having the same PID. The scalability information inserter 650 may insert the scalability information into only the TS packet 110 including the data of the NALU header 530 among the at least one MPEG-2 TS packet having the same PID.

The above technical information described herein with reference to FIGS. 1 to 5 may equally be applied to the present embodiment. Accordingly, a detailed description thereof will be omitted.

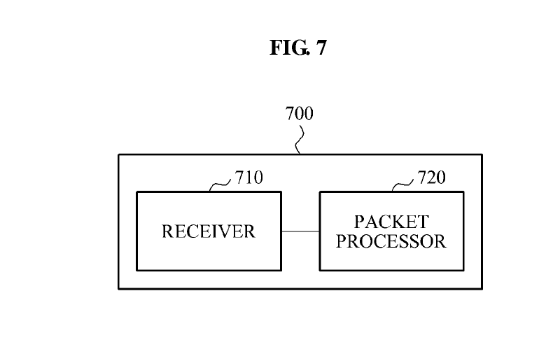

FIG. 7 is a diagram illustrating a structure of a streaming client 700 according to an embodiment of the present invention.

The streaming client 700 may be a MPEG-2 TS processing apparatus used to process an MPEG-2 TS generated by the streaming server 600.

The streaming client 700 may be an apparatus for receiving and processing the TS 100 generated by the above-described streaming server 600. The TS 100 may include a scalable video stream, and a header of the TS packet 110 may include scalability information of the scalable video stream.

The streaming client 700 may include a receiver 710, and a packet processor 720.

The receiver 710 may receive the TS 100.

The packet processor 720 may process the TS packet 110 in the TS 100.

An operation of the packet processor 720 may correspond to an operation of the packet generator 610.

For example, the packet processor 720 may determine whether scalability information and view information exist in the TS packet 110, based on the view_info_flag 320 in the TS header 112.

Additionally, the packet processor 720 may generate, based on the scalability information, the scalability information included in the NALU header 530 of the SVC.

The packet processor 720 may extract the scalability information, only when the data of the NALU header 530 exists in the TS packet 110.

The packet processor 720 may extract scalability information from only the TS packet 110 including the data of the NALU header 530 among at least one TS packet 110 having the same PID 130.

Additionally, a specific TS packet may not include scalability information. In this instance, the packet processor 720 may extract scalability information from a TS packet of a previous time that 1) includes scalability information and that 2) is located closest to the specific TS packet, among the at least one TS packet 110 having the same PID 130 as the specific TS packet, and may use the extracted scalability information as scalability information of the specific TS packet.

The above technical information described herein with reference to FIGS. 1 to 6 may equally be applied to the present embodiment. Accordingly, a detailed description thereof will be omitted.

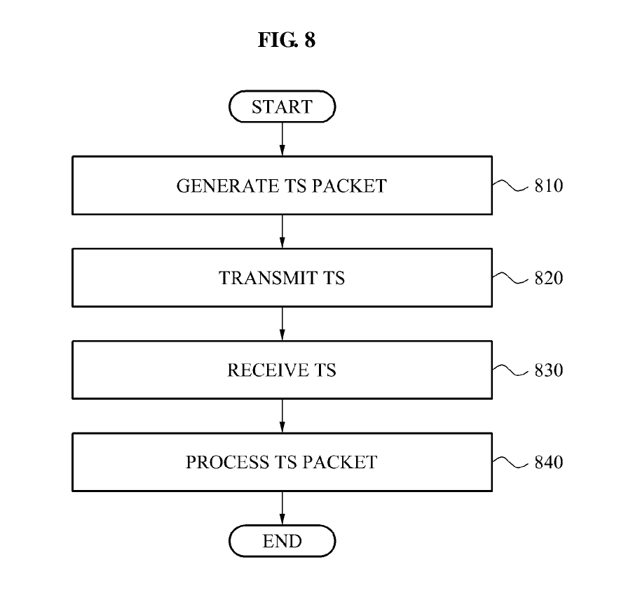

FIG. 8 is a flowchart of a streaming service method 800 according to an embodiment of the present invention.

The streaming service method 800 may be used to process the MPEG-2 TS of FIG. 6.

In operation 810, the TS packet 110 may be generated, for example, by the packet generator 610 of the streaming server 600.

In operation 820, the TS 100 generated using the TS packet 110 may be transmitted, for example, by the transmitter 620 of the streaming server 600.

The TS 100 may include the scalable video stream, and the header of the TS packet 110 may include the scalability information of the scalable video stream.

In operation 830, the TS 100 may be received, for example, by the receiver 710 of the streaming client 700.

In operation 840, the TS packet 110 in the TS 100 may be processed, for example, by the packet processor 720 of the streaming client 700.

The above technical information described herein with reference to FIGS. 1 to 7 may equally be applied to the present embodiment. Accordingly, a detailed description thereof will be omitted.

The existing MPEG-2 system may be extended through the streaming server 600, the streaming client 700, and the streaming service method 800. Additionally, a scalable video multiplexed by the TS packet 110 may be adapted in a form suitable for various terminal performances, a network status, a user preference, and the like. The TS packet 110 may be efficiently extracted from the TS 100.

The method according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A streaming server, comprising:
a packet generator to generate a Moving Picture Experts Group-2 (MPEG-2) Transport Stream (TS) packet; and
a transmitter to transmit an MPEG-2 TS using the MPEG-2 TS packet,
wherein the MPEG-2 TS comprises a scalable video stream, and
wherein a header of the MPEG-2 TS packet comprises scalability information of the scalable video stream.

2. The streaming server of claim 1, wherein the scalable video stream is divided, and the divided scalable video stream exists in a payload of the MPEG-2 TS packet.

3. The streaming server of claim 1, wherein the scalability information exists in transport private data of the header.

4. The streaming server of claim 1, wherein the transport private data exists in an optional field in an adaptation field of the header.

5. The streaming server of claim 1, wherein the header comprises a scalability information flag indicating presence or absence of the scalability information, and a view information flag indicating presence or absence of view information of the scalable video stream.

6. The streaming server of claim 5, wherein the header comprises a private data flag indicating whether the scalability information flag and the view information flag exist.

7. The streaming server of claim 5, wherein the scalability information comprises spatial scalability information of the scalable video stream, temporal scalability information of the scalable video stream, and quality scalability information of the scalable video stream.

8. The streaming server of claim 5, wherein the view information exists in the transport private data of the header.

9. The streaming server of claim 5, wherein the packet generator generates the view information using second view information in a Network Abstraction Layer Unit (NALU) header of a Multi-view Video Coding (MVC).

10. The streaming server of claim 1, wherein the packet generator generates the scalability information using second scalability information in a NALU header of a Scalable Video Coding (SVC).

11. The streaming server of claim 10, wherein the packet generator generates the scalability information only when data of the NALU header exists in the MPEG-2 TS packet.

12. The streaming server of claim 11, wherein the packet generator generates the scalability information in only the MPEG-2 TS packet including the data of the NALU header, among at least one MPEG-2 TS packet having the same Packet Identifier (PID).

13. The streaming server of claim 1, wherein the packet generator comprises a scalability information inserter to insert the scalability information into the MPEG-2 TS packet.

14. A streaming client, comprising:
a receiver to receive a Moving Picture Experts Group-2 (MPEG-2) Transport Stream (TS); and
a packet processor to process an MPEG-2 TS packet in the MPEG-2 TS,
wherein the MPEG-2 TS comprises a scalable video stream, and
wherein a header of the MPEG-2 TS packet comprises scalability information of the scalable video stream.

15. The streaming client of claim 14, wherein the packet processor determines whether the scalability information and view information of the scalable video stream exist in the packet, based on a scalability information flag and a view information flag that are included in the header.

16. The streaming client of claim 14, wherein the packet processor generates, based on the scalability information, scalability information in a Network Abstraction Layer Unit (NALU) header of a Scalable Video Coding (SVC).

17. The streaming client of claim 14, wherein the packet processor extracts the scalability information, only when data of the NALU header is included in the MPEG-2 TS packet.

18. The streaming client of claim 17, wherein the packet processor extracts the scalability information from only the MPEG-2 TS packet including the data of the NALU header, among at least one MPEG-2 TS packet having the same Packet Identifier (PID).

19. The streaming client of claim 18, wherein the packet processor extracts the scalability information of the MPEG-2 TS packet from a second MPEG-2 TS packet of a previous time that comprises the scalability information and that is located closest to the MPEG-2 TS packet, among the at least one MPEG-2 TS packet having the same PID.

20. A streaming service method, comprising:
generating a Moving Picture Experts Group-2 (MPEG-2) Transport Stream (TS) packet; and
transmitting an MPEG-2 TS generated using the MPEG-2 TS packet,
wherein the MPEG-2 TS comprises a scalable video stream, and
wherein a header of the MPEG-2 TS packet comprises scalability information of the scalable video stream.
